(19) United States
(12) Patent Application Publication
(10) Pub. No.: US 2014/0357219 A1
(43) Pub. Date: Dec. 4, 2014

(54) Method and System of Handling Mobile Roaming

(71) Applicants: Gheorghe NICOLAESCU, McLean, VA (US); Grygoriy PARSHIN, Rishon Lezion (IL)

(72) Inventors: Gheorghe NICOLAESCU, McLean, VA (US); Grygoriy PARSHIN, Rishon Lezion (IL)

(73) Assignee: GINNESS, LLC, Wilmington, DE (US)

(21) Appl. No.: 14/158,766

(22) Filed: Jan. 17, 2014

Related U.S. Application Data
(63) Continuation of application No. PCT/IB2014/058198, filed on Jan. 11, 2014.
(60) Provisional application No. 61/830,165, filed on Jun. 2, 2013.

(51) Int. Cl. H04M 15/00

(52) U.S. Cl. CPC H04M 15/8038
USPC 455/406

(57) ABSTRACT

Methods of handling traffic and charges for mobile data roaming of a subscriber of mobile services on a home and visited network that includes an infrastructure for global roaming partnership management, local internet access for visiting subscribers in the visiting country, a single data roaming partnership agreement followed by comparing a call detail record to records in a database to identify a subscriber with a special international roaming agreement. A special transferred account procedure file is created for an identified subscriber with a special international roaming arrangement and the special transferred account procedure file is forwarded to a global roaming partnership system. For subscribers that do not have a special international roaming arrangement the call detail record is incorporated into a transferred account procedure file and routed to a data clearinghouse.

### CROSS-REFERENCE TO RELATED APPLICATIONS

This utility patent application under 35 USC §111 is a continuation of international patent application PCT/IB2014/058198 filed on Jan. 11, 2014 and claims priority to U.S. provisional patent application 61/830,165 filed on Jun. 2, 2013, which is incorporated by reference herein.

### TECHNICAL FIELD

The present invention relates to wireless communications and, more particularly, to international roaming.

### BACKGROUND

Currently, mobile data roaming consists of several intertwined technical implementations, interconnection and signaling standards, commercial arrangements, enablers, infrastructure, practices and market constraints. Mobile data roaming occurs when a client of a certain network is served by a physical (radio) infrastructure of another network either nationally or internationally. The network to which the roaming mobile client (mobile roamer) belongs is referred to as the home network while the one serving the mobile roamer at the moment, is referred to as the visited network.

While the mobile roamer is served by the visited network, actual Internet access is achieved through the home network.

A service agreement between the networks is a prerequisite for service provisioning by both the home and visited networks.

One practical implication of this arrangement is the need to transfer data going from the mobile roamer to the Internet and from the Internet to the mobile roamer between the visited network where the mobile roamer gains physical access and the home network where actual Internet access is performed.

A primary reason for this arrangement at the time of inception in the late 1990s and early 2000 was control of the mobile roamer's access to the Internet by the home network through access point names (APNs) set on the mobile handset. The need to transfer data between the networks also has the effect of requiring dedicated data transfer infrastructure which is currently implemented by a network of logical/physical entities known as general packet radio service (GPRS) roaming exchange (GRX) and an Internetwork packet exchange (IPX).

Usually, GRX is based on a private or public Internet protocol (IP) backbone and uses GPRS tunneling protocol (GTP). Each GRX operator has a network consisting of a set of routers and links connecting to the GPRS networks, moreover the GRX networks have links connecting to other GRX nodes in a peer model.

A simplified high-level architecture of the GRX covering both roaming and interworking interconnection cases is illustrated in FIG. 1B.

The GRX consists of separate and competing GRX providers (or GRX carriers). A GRX network can be operated by any qualified party. GRX providers connect to each other via peering interfaces. These peering interfaces may be direct connections or may pass through a common peering point. GRX providers should typically into service level agreements (SLAs) with other GRX providers.

A common domain name system (DNS) root database supports domain name resolution. This root database may be used by all GRX parties.

Referring to FIG. 1C, the IPX builds on the features of the GRX, and the IPX also is able to support the following: connectivity between any type of service provider; end-to-end QoS for roaming and interworking; and IP services on a bilateral basis with end-to-end QoS and interconnect charging.

An IPX may also use the service-aware functionality of the IPX proxies to support: further interconnect charging models such as service-based charging in addition to the volume-based model of GRX; inter-operable interworking for specified IP services; and multilateral interworking support for these specified services over a single service provider to an IPX connection.

The IPX builds upon and extends the architecture of the GRX by introducing a number of other stakeholders—fixed network operators, Internet service providers and application service providers, which together with mobile network operators are hereafter termed service providers. The IPX is formed from separate and competing IPX providers.

As explained above, roaming is connectivity service in a location that is different from the home location where the subscriber is a customer. Roaming ensures that the wireless device is kept connected to the network without losing a connection.

Location updating is the mechanism that is used to determine the location of a mobile station in the idle state. When the mobile device is turned on or is transferred via a handover to the network, this new “visited” network sees the device, notices that it is not registered with its own system, and attempts to identify its home network.

If there is no roaming agreement between the two networks, maintenance of service is impossible, and service is denied by the visited network. The visited network contacts the home network and requests service information (including whether or not the mobile should be allowed to roam) about the roaming device using the international mobile subscriber identity number. If successful, the visited network begins to maintain a temporary subscriber record for the device. Likewise, the home network updates its information to indicate that the cell phone is on the host network so that any information sent to that device can be correctly routed.

The usage by a subscriber in a visited network is captured in a call detail record (CDR). The CDR (also known as call data record) is a data record produced by a telephone exchange or other telecommunications equipment that contains attributes that are specific to a single instance of a phone call or other communication transaction that was handled by that facility or device. A CDR contains metadata containing data fields that describe a specific instance of a telecommunication transaction, but does not include the content of that transaction.

A CDR describing a particular phone call might include, for example, the phone numbers of both the calling and receiving parties, the start time, and duration of that call. In more detail, CDRs may contain attributes such as: the phone number of the subscriber originating the call (calling party); the phone number receiving the call (called party); the starting time of the call (date and time); the call duration; the billing phone number that is charged for the call; the identification of the telephone exchange or equipment writing the record; a unique sequence number identifying the record; additional digits on the called number used to route or charge the call; the disposition or the results of the call, indicating, for example, whether or not the call was connected; the route by which the call entered the exchange; the route by which the call left the exchange; call type (voice, SMS, etc.); and, any fault condition encountered. Different network operators sometimes use CDRs with some different formats and/or information.

A transferred account procedure (TAP) file be may the format of the CDR or it may be created from the CDR. Transferred account procedure protocol allows a visited network operator to send billing records of roaming subscribers to their respective home network operator. Clearing houses may use a TAP protocol to exchange all the CDRs between different roaming partners. TAP3 currently defines how and what information on roamed usage must be passed between network operators on a global system for mobile communications (GSM) network. The TAP file contains details of the calls made by the subscriber including location, calling party, called party, time of call and duration.

More generally, TAP refers to any protocol that allows transfer of files from a visited network operator to send billing records of roaming subscribers to their respective home network operator. For example, the CDR may be in the format of cellular intercarrier billing exchange record (CIBER) for a code division multiple access (CDMA) network.

Generally, there are two types of roaming: 1.) national roaming to move from one mobile operator to another in the same country. In many cases, national roaming costs are more dependent on regulatory oversight rather than on business negotiations or market demand. 2.) international roaming to access mobile service in a foreign (country) service provider's network. International roaming is frequently operated under the GSM standard which is used by many of the world's mobile operators.

As noted above, a prior agreement between the home and visited networks is a prerequisite for the provision of mobile data roaming. Such an agreement regulates various issues such as accessibility, tariffs paid by the home network to a visited network for serving its clients, limitations in quantity of served users, mutual obligations with regard to quantities of served users as well as QoS with regard to the latter, etc.

Tariffs established between operators are known as interoperator tariffs or IOTs. The IOTs are independent of the GRX infrastructure and are concluded and managed by operators or entities, providing IOT management services, known as roaming hubs.

Historically IOTs have been set very high due to low projected usage at the dawn of the mobile Internet era, large investments in data networks and GRX services and respective high mobile Internet prices in home networks.

High TOT prices are the primary reason for the unrealistically high mobile data roaming prices. The TOT prices for mobile data roaming paid by the home network to visited networks to gain access to a foreign data network IOTs exceed charges paid locally by consumers 100 or even 1000 fold.

### SUMMARY

There are different approaches to handling charges for mobile data roaming of a subscriber of mobile services from a home network that is roaming on a visited network.

In one general aspect, a method of handling charges of a subscriber of a home network roaming on a visited network includes intercepting one or more call detail record produced by the visited network prior to transmission of a data file that includes the one or more call detail record to a data clearinghouse and removing an identified call detail record from the data file when the subscriber for the identified call detail record has a special international roaming arrangement.

Embodiments may include one or more of the following features. For example, the data file may be a transferred account procedure (TAP) file or a cellular intercarrier billing exchange record (CIBER).

The removed call detail record may be sent to a first server or a global roaming partnership system connected between the visited network and the home network. The data file may be transmitted to a data clearinghouse connected between the visited network and the home network.

One or more call detail record may be compared to records in a database that include subscribers with a special international roaming arrangement. The one or more call record may be intercepted by a mini data clearinghouse or a first server installed at the visited network.

In another general aspect, a method of handling roaming charges for a subscriber of mobile services on a visited network includes comparing one or more call detail record to records in a database that include subscribers with a special international roaming arrangement, creating a special roaming customer record from the call detail record when the subscriber is identified as having a special international roaming arrangement, forwarding the special roaming customer record of the identified subscriber to a remote server connected to the visited network and a home network of the identified subscriber and forwarding a data file that includes the call detail record of the subscriber to a data clearinghouse when the subscriber is not identified as having a special international roaming arrangement.

Embodiments may include one or more of the above or following features. For example, the data file may be a transferred account procedure (TAP) file or a cellular intercarrier billing exchange record (CIBER). The special roaming customer record may also be a transferred account procedure.

A first server or a mini data clearinghouse may be installed at the visited network. The first server may include the database to compare the call detail record of the subscriber to records in the database on the first server at the visited network.

A second server or a global roaming partnership system may connected to the visited network and a home network of the subscriber. The comparison of the call detail record of the subscriber to records in the database may be at the second server global roaming partnership system.

The call detail record may be received from a mediation billing platform of the visited network. The call detail record for the subscriber may be intercepted prior to receipt by a billing system or a roaming relations manager of the visited network. The call detail record for the subscriber may also be intercepted prior to transmission of the call detail record to a data clearing house.

The call detail record may be compared in binary or normalized formats to the records in the database to identify a subscriber with a special international roaming arrangement.

In a further general aspect, a method of handling charges for mobile data roaming of a subscriber of mobile services on a foreign network includes intercepting a call detail record at the foreign network for the subscriber that accesses the foreign network, comparing the call detail record of the subscriber to records in a database that include subscribers with a special international roaming arrangement, routing the call detail record to a global roaming partnership system when the subscriber is identified as having the special international roaming agreement, routing the call detail record to a data clearinghouse when the subscriber is not identified as having the special international roaming agreement.

Embodiments may include one or more of the above or following features. For example, the the call detail record may be removed from records sent from the foreign network to the data clearinghouse when the roaming subscriber is identified as having the special international roaming arrangement.

In still another general aspect, a system to handle charges for international roaming of a subscriber of mobile services on a foreign network includes a first mini data clearinghouse installed on the foreign network to compare one or more call detail record produced by the foreign network to records in a database to identify subscribers with special international roaming agreements and a global roaming partnership system connected to the first mini data clearinghouse and to a second mini data clearinghouse installed at the home network of the subscriber. The global roaming partnership system includes a master database for subscribers with special international roaming agreements and the master database updates the database at the first mini data clearing house. The first mini data clearinghouse server determines whether to forward the one or more call detail record to the data clearinghouse for the foreign network when the subscriber does not have a special international roaming arrangement or to forward the one or more call detail record to the global roaming partnership system when the subscriber has a special international roaming arrangement.

Embodiments may include one or more of the following or above features. For example, a database management system may reside at the global roaming partnership system to manage the master database.

In still another general aspect, a method of handling charges for mobile data roaming of a subscriber of mobile services on a visited network based on comparing CDRs to records in a database to identify a subscriber with a special international roaming agreement. A special transferred account procedure (STAP) file is created for an identified subscriber with a special international roaming arrangement and the STAP file is forwarded to a global roaming partnership system. For subscribers that do not have a special international roaming arrangement the CDR is incorporated into a TAP file and routed to a data clearinghouse.

The method may include one or more of the following features. For example, a CDR may be prepared for the subscriber on the visited network. The CDR may be from a mediation billing platform of the visited network. The CDR that is compared may be in a binary or a normalized format.

In another general aspect, a method of handling charges for international data roaming of a subscriber of mobile services on a foreign network includes comparing a general TAP file to a database to identify a subscriber with a special international roaming agreement, creating a STAP file of an identified subscriber with the special international roaming arrangement, removing a record of mobile data usage of the identified subscriber from the general TAP file, and routing the special TAP file to a global roaming partnership system.

The method may include any of the above or following features. For example, the general TAP file with the removed data record of the identified subscriber may be routed to a data clearinghouse.

One method of handling mobile data roaming is based on a connection between the visited network and the GRPS system for traffic and charging handling.

In the proposed method, traffic handling of mobile data roaming is based on implementation of local breakout to the Internet through a GRPS point of presence (POP) which consists of several network elements such as a cloud-based communication module and a cloud-based management module, etc.

As used herein, the term cloud or cloud-based refers to ubiquitous and convenient on-demand network access to a shared pool of configurable computing/network resources (e.g., data networks, servers, data storage devices, applications and services—either together or separately) that can be provided quickly and released with minimal operating costs and/or appeals to the provider.

### BRIEF DESCRIPTION OF THE DRAWINGS

FIGS. 1A, 1B and 1C illustrate background information regarding telecommunications networks;

FIGS. 2A and 2B illustrate the structure of the currently used system;

FIG. 3 shows a new international roaming processing system; and

FIGS. 4-6 show implementation methods for the international roaming processing system;

FIG. 7 illustrates a cloud-based global roaming partnership system;

FIG. 8 shows a message flow diagram for a conventional roaming data user;

FIG. 9 shows a cloud-based message flow diagram;

### DETAILED DESCRIPTION

### Phase One

The records of international roaming customers that are collected in TAP files include a number of fields, such as the MSISDN, number of incoming calls, time of the incoming calls, number of outgoing calls, time of the outgoing calls, data usage, etc. The MSISDN is a number uniquely identifying a subscription in a GSM or a UMTS mobile network. In other words, it is the telephone number to the (subscriber identity module) SIM card in a mobile/cellular phone. An example of a TAP file is shown in Table 1:

TABLE 1

| | | | | | | |
|---|---|---|---|---|---|---|
| MSISDN | Number of | Duration of | Number of | Duration | Data | . . . |
| | incoming | incoming | outgoing | of | usage | |
| | calls | calls | calls | outgoing | | |
| | | | | calls | | |

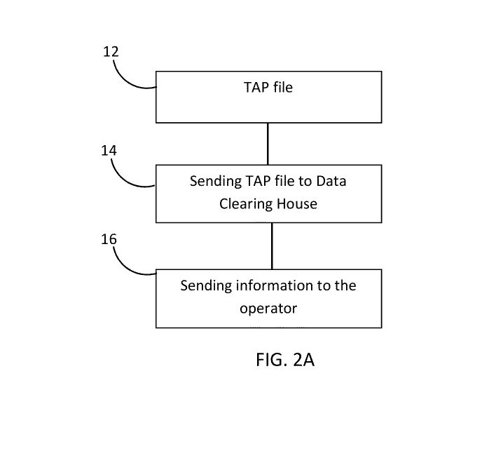

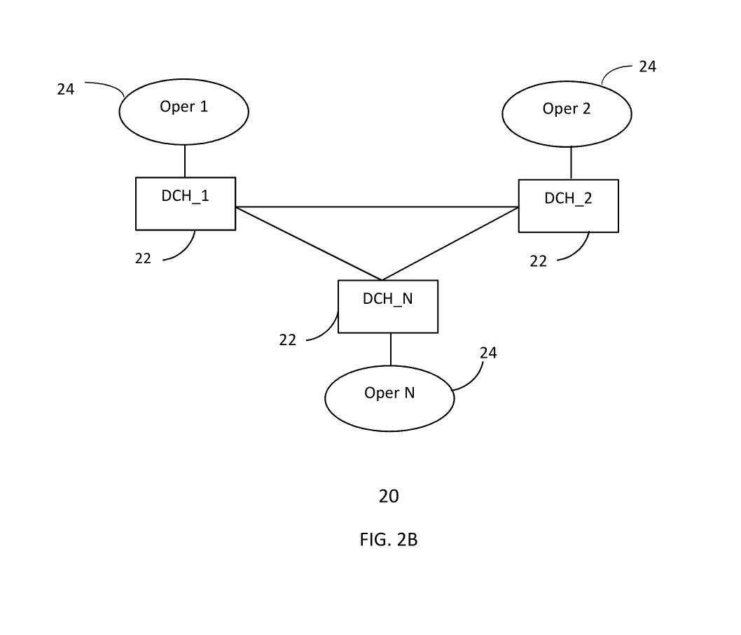

The currently used system 10 is shown in FIG. 2A. A TAP or general TAP file is prepared by the visited network. The general TAP file 12 is then sent 14 to a data clearinghouse (DCH). The information from the DCH is sent to the home operator 16. The information is sent all together, in a set of records and the individual user's data is not separated from the entire file. The system 10 sets fees that rely on the conventional inter-operator tariff, which does not allow creating any special data package deals for individual users.

FIG. 2B shows a model of conventional operator to operator communication 20 through multiple DCHs 22. Each network operator 24 has a DCH 22 that acts as an interface between different roaming partners to help them to exchange TAP files, set up roaming agreements and resolve disputes. DCHs 22 receive billing records from one roaming partner for the inbound roamers and submit billing records to another roaming partner for which this roamer would be called an out-bound roamer. The operators 24 share TAP files but typically each operator 24 uses only one DCH 22.

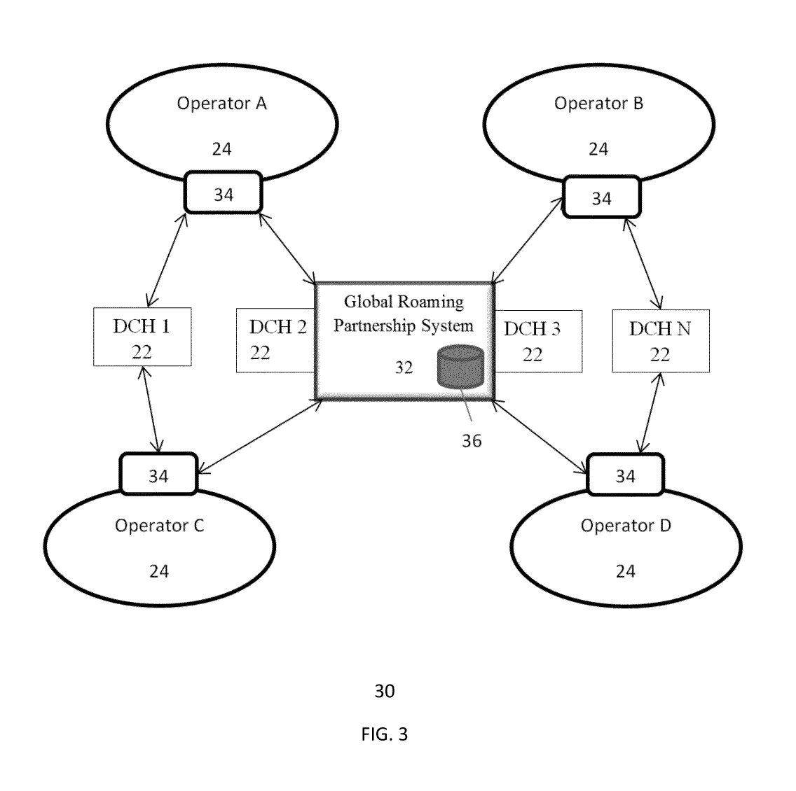

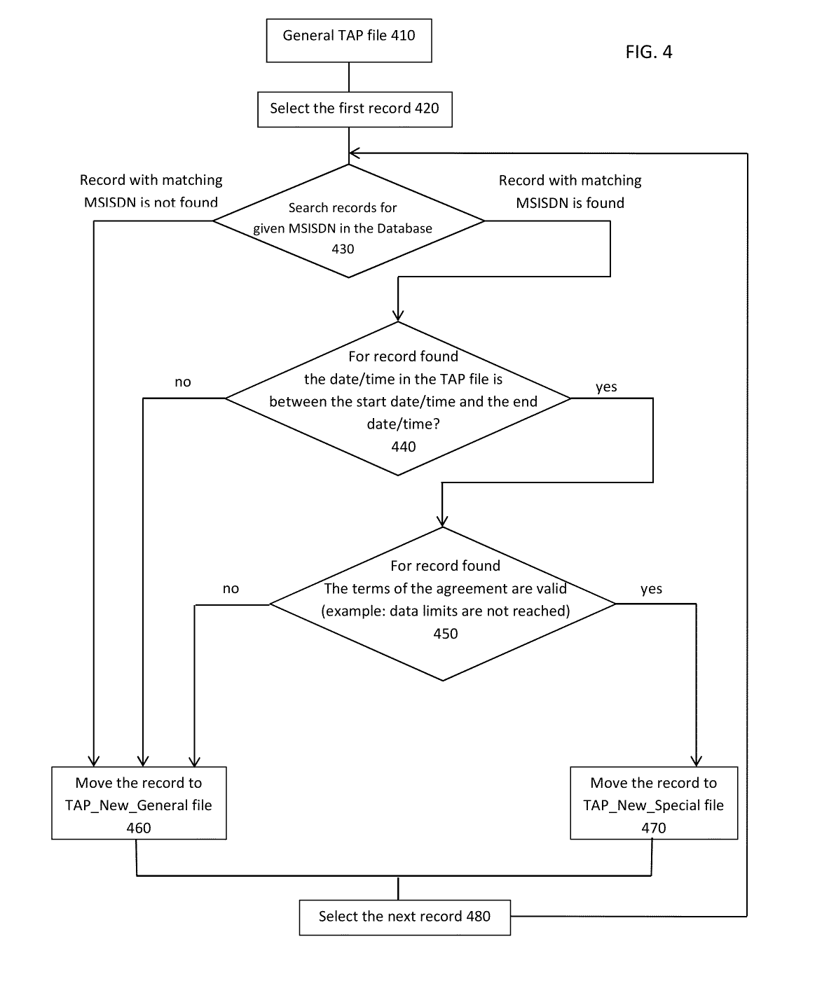

FIG. 3 illustrates a new implementation of a global roaming partnership system 32 (GRPS). The system 30 provides an alternative billing procedure so that subscribes can have special agreements for mobile roaming, particularly for data roaming. Essentially, the system provides for the separate handling of billing for mobile data roaming that bypasses the routine processing through the DCH 22. This makes it possible for the home operator to offer differentiated data packages for purchase under special agreements between subscribers and providers with the purpose of lowering subscriber costs for mobile data roaming while simultaneously increasing carrier revenue by providing an incentive for the subscriber to use a data plan provided by the home network instead of switching to alternative data networks.

In this system, a mini data clearing house (MDCH) 34 is installed at each network operator 24 location. The MDCH 34 is the equipment responsible for identifying and extracting from the TAP file the personal records of the subscribers with special agreements. In other implementations described below, CDR files are screened by the MDCH 34 before they become TAP files.

Each operator can has its own MDCH 34. Alternatively, MDCH modules may each be located on separate computers connected to the operator 24 over a network, such as the Internet. The MDCH can have memory, such as, a fixed disk where an operating system, application programs, and/or data may be stored. For the purposes of this disclosure a MDCH module is software, hardware, or firmware (or combinations thereof) system, process or functionality, or component thereof, that performs or facilitates the processes, features, and/or functions described herein (with or without human interaction or augmentation).

Software components of a MDCH may be stored on a computer readable medium. The MDCH may be integral to one or more servers, or be loaded and executed by one or more servers. The software components may be grouped into an engine or an application and implemented by at least one processor of a computing device.

When an agreement between a user and a provider is established a record in the database 36 is created. The database 36 consists of the records of the users—subscribers of data roaming packages purchased from their home providers. Each of the network operators 24 sends subscriber information to the database 36 in real time and the information can be downloaded to each DCH 26. In one embodiment, a primary database can be located at the GRPS 32 and the MDCH 34 polls the GRPS to update a database located on each MDCH 34. In another embodiment, the MDCH 34 directly accesses the database 36 located on the GRPS 32 to make the subscriber information comparison with the CDR or TAP file. The transfer of information and records between each MDCH 34 and the GRPS 32 may be on a platform that utilizes near-real time roaming data exchange.

The database 36 can be located on database servers which are dedicated computers that hold the actual databases and run only a database management system and related software. The database servers can be multiprocessor computers, with generous memory and RAID disk arrays used for stable storage. Hardware database accelerators, connected to one or more servers via a high-speed channel, can also be used to process transactions quickly.

Among the database fields are MSISDN and period of time the agreement is active (start date/time and end date/time) as well as the terms of the agreement such as the limits of the data usage, the price for megabyte, etc., as shown in Table 2.

TABLE 2

| | | | | | |
|---|---|---|---|---|---|
| MSISDN | Start date/time | End date/time | Data limits | Price | . . . |

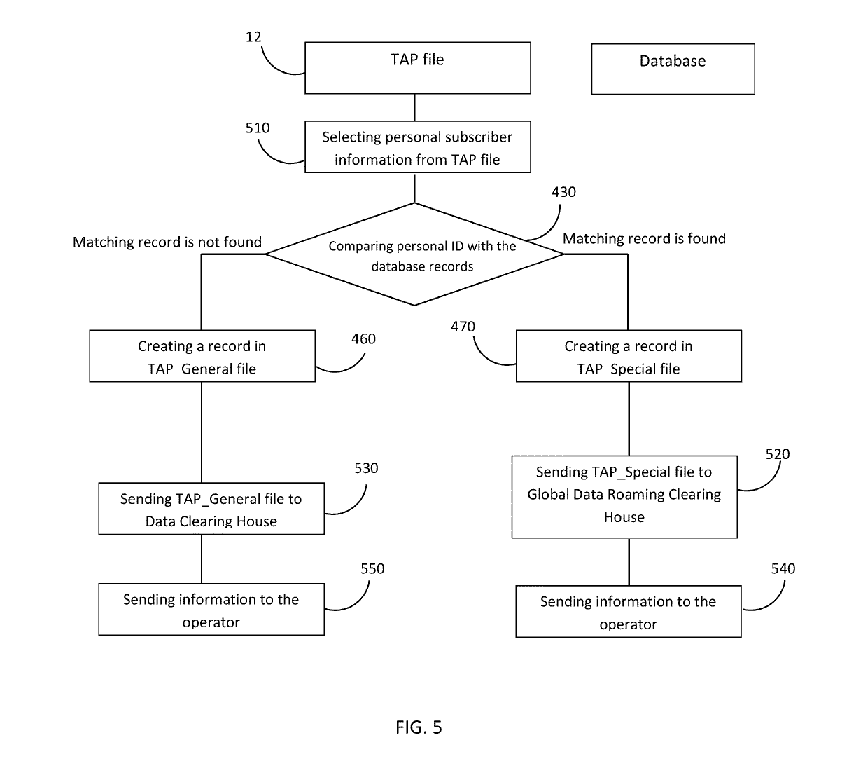

Referring to FIG. 4, the general TAP file sourced to the MDCH can be separated into two TAP files: one (TAP_Special file) consisting of the records with information on data package subscribers is sent to the GRPS 32, and the other (TAP_General file) consisting of the records of regular users is sent to the DCH 22 and processed conventionally.

This occurs by comparison to the database 36 records in operation 430. Each record is compared to a database to find a matching MSISDN. If no match is found, the record is moved to the TAP_General file in operation 460. The TAP_General file uses standard billing charges according to general tariff agreement between the network operators.

If the record has a MSISDN that matches a special subscriber in the database 36, the system determines if the subscriber is eligible for a special roaming rate in operation 440. Other terms of the special agreement are also validated in operation 450. For example, the system can determine whether data limits are exceeded or other terms are not verified.

For example, if the data limits are exceeded the record is moved to the TAP_General file in operation 460. If the data limits are not exceeded the record is moved to a TAP_Special file in operation 470. The billing and charges to the subscriber are calculated according to rates set forth in that subscriber's special roaming agreement that is stored in the database 36 at the GRPS 32.

Another record is then selected for comparison in operation 480 and the process is repeated.

FIG. 5 shows the communication flow from the foreign network operator to the home network operator. The TAP file is routed to the MDCH 34 to identify subscriber information in the TAP file in operation 510. As described with respect to FIG. 4, the subscriber information is compared to the database records in operation 430 to create TAP_General files (460) or TAP_Special files (470).

The TAP_special files are sent from the MDCH 34 to the GRPS 32 in operation 520. The TAP_General files are routed to the DCH 22 in operation 530. In operation 540, the GRPS sends the TAP_Special file to the home network operator. In operation 550, the DCH sends the TAP_General file to the home network operator.

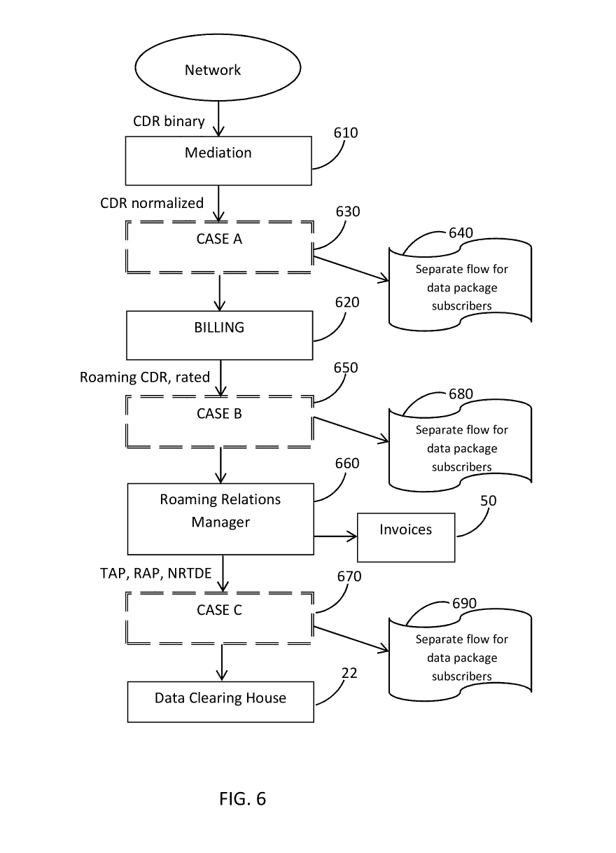

FIGS. 4 and 5 above illustrate one of the approaches to implement the new system. However, FIG. 6 shows the workflow of the system with a variety of methods of integration into current systems. The network sends the information of roaming mobile data usage to a mediation billing platform (mediation) 610 in binary files referred to as call detail records (CDRs). Mediation platforms are used to process CDRs or usage detail records (UDRs). The mediation billing platform decodes the binary files, selects roamers and sends the information in a separate flow to a billing system 620 for rating. In call scenarios UDRs are most often known as CDRs but may also be referred to as Internet protocol detail records (IPDR) by broadband carriers.

The CDR/UDR data types could hold data such as NPX, NPA, call duration, peak time flag, call length and this data may be represented in binary formats. The billing mediation platform 610 typically reads this data and converts it into a common normalized format.

There are at least three implementations of the system to intercept or screen the CDR or TAP files. In any of these implementations, CDR records that are intercepted and identified as having special roaming eligibility may be removed from the TAP files that would otherwise be routed to the operator's associated data clearing house. The first screening approach in Case A 630 is to filter CDRs just after the mediation system 610 and process information about data package subscribers in a separate flow 640. In Case A, the individual customer records are processed by a separate roaming relations manager that is not part of the network operator's system.

The second implementation shown in Case B 650 is to intercept the data right after the billing process 620. Case B 650 intercepts the data flow before passing it to the roaming relations manager 660 and filters the records related to roaming data package subscribers to process them separately for each user record 680.

The third implementation of the system is shown by Case C 670 is to screen TAP files after processing by the roaming relations manager 660. The TAP files are separated into two sets of TAP files—files with regular user information, which are sent to the DCH 22, and another set of files with information on users with special data packages bought from the home provider, which are sent to GRPS 32 shown in operation 680. The detailed process of separation of the TAP files into “general” files and “special” files is explained above with respect to FIGS. 4 and 5.

The system described above uses a GRPS 32 that provides an alternative billing procedure for customers with special data packages for international roaming. The invented system allows using the same protocols for the network users to maintain service with their current operator while having charges processed according to a special agreement. The customer remains connected to a home network operator 24 instead of finding alternative networks for data access since the customer can have a special mobile data roaming package that is provided by the home network operator 24.

The transferred account procedure files mentioned above may include any version of TAP such as TAP3 or TAP3.12 and refers more generally to any files that are transferred to allow a visited network operator to send billing records of roaming subscribers to their respective home network operator.

The process of signing up as subscribers for special international roaming service is fairly straightforward. The potential customer would log onto a website that provides various service options. For example, the customer may have options of 500 MB for $50 US, 1 GB for $75 US and 2.5 GB for $100.

The potential customer selects a desired plan and provides customer information including the customer address, billing information and MSISDN. Certain of the customer information is forwarded to the database 36 at the GRPS. The database 36 may also update a database in each MDCH 34 in real-time.

Once the customer becomes a subscriber of a special international roaming arrangement he does not need to do anything further to access international roaming. The GPRS works in partnership with network operators to bill clients. Since records are updated in real-time, the subscriber can be notified if there is any issue related to service such as exceeding data limits.

### Phase 2

The proposed system consists of cloud-based GRPS connectivity and management modules. Cloud-based GRPS connectivity modules are proposed to enable local Internet access for inbound users of any visited network. The traditional complex mesh of point-to-point connections between all operators is replaced by a single connection into the cloud-based GRPS for each operator/country combination. This in turn is managed through a single agreement between the operator and the cloud-based GRPS Management module. The effect of a cloud-based system for every visited network would be an ability to serve inbound roamers with payment guaranteed by the home network, yet without complex agreements and without setting up dedicated billing and collection mechanisms.

Every operator, acting as a home and a visited network would have only one agreement with the cloud-based GRPS. Crucially, since all home and visited networks are connected to the cloud-based GRPS, the outbound user remains visible to their home network and is retained as their revenue stream—irrespective of location.

### Cloud GRPS Solution Overview

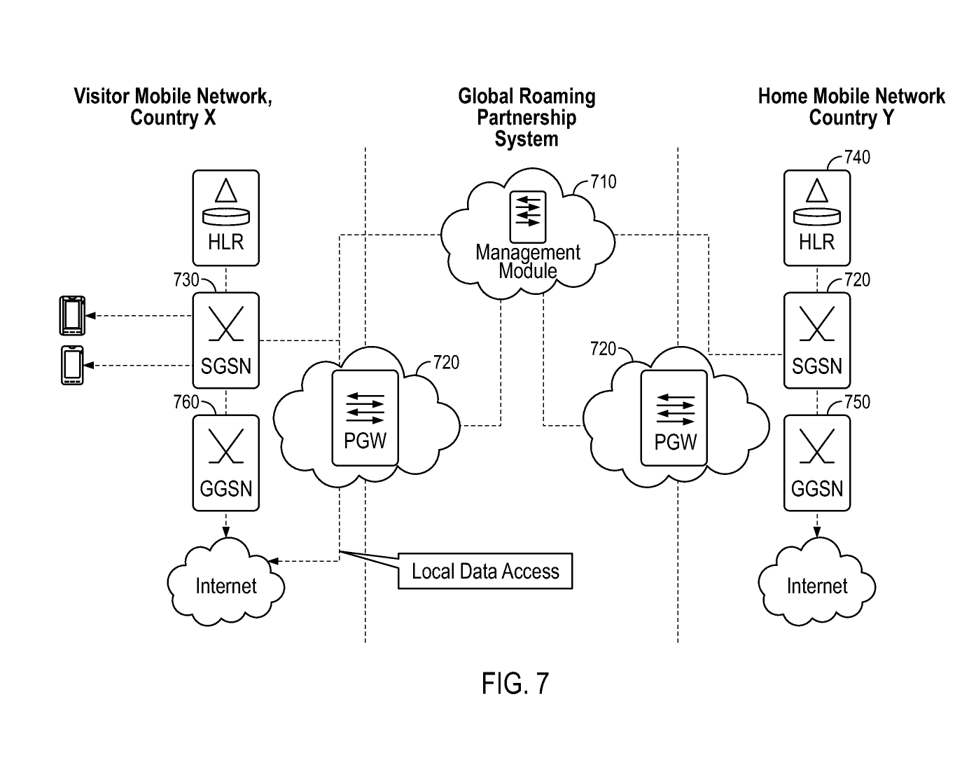

Referring to FIG. 7, a cloud-based global roaming partnership system (GPRS) includes several logical elements which are described below Like the Phase I GPRS roaming system, the system is based on GSMA standards for home and visited mobile network interconnection. The roaming data scenario is described above.

The proposed cloud-based system allows the visited user to connect to the cloud-based system instead of a home PLMN GPRS sub-system. The global roaming partnership system consists of a cloud-based management module 710 and a cloud-based communication module 720.

### Communication Module

The communication module 720 handles roaming traffic instead of sending it to the home network. The communication module 720 is a packet data network gateway (PGW) that is responsible for terminating GTP protocol sessions from the visitor serving GPRS support node (SGSN) 730 subsystem. The PGW tracks data usage sessions per subscriber and sends CDRs to the cloud-based management module charging function. PGWs provide IP connectivity access network (IPCAN) session security via a firewall and act as a lawful intercept point to security agencies via X open transport interface. The PGW can provide additional traffic policy functions, such as, deep packet inspections and traffic adaptation and optimization.

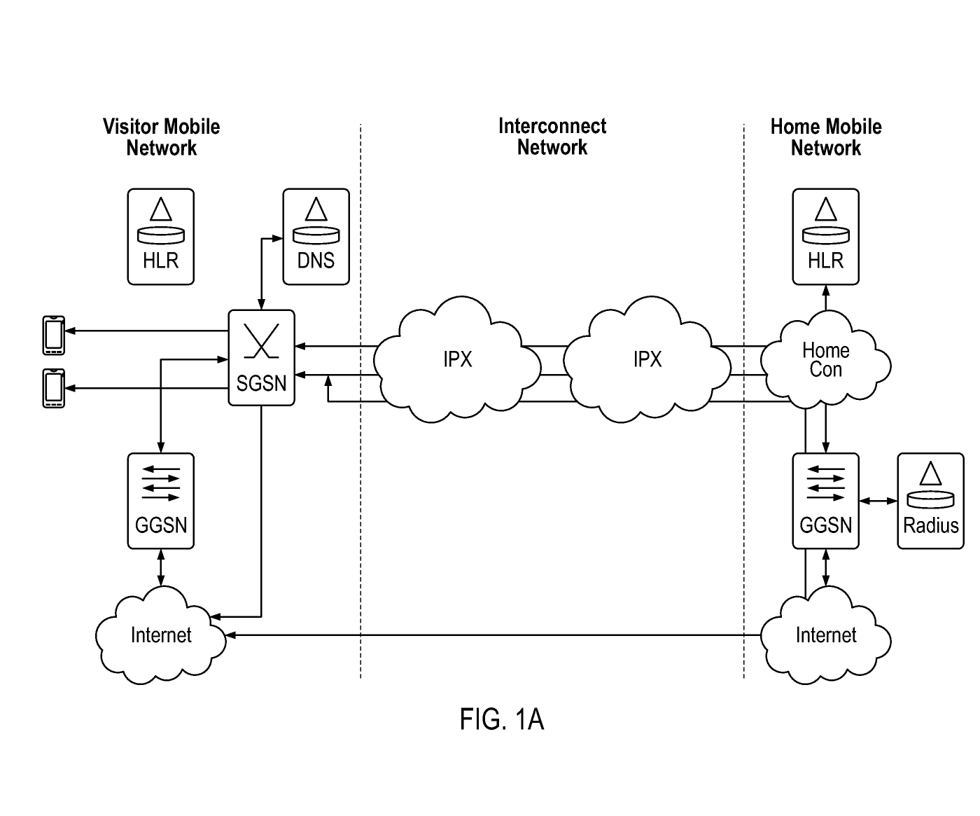

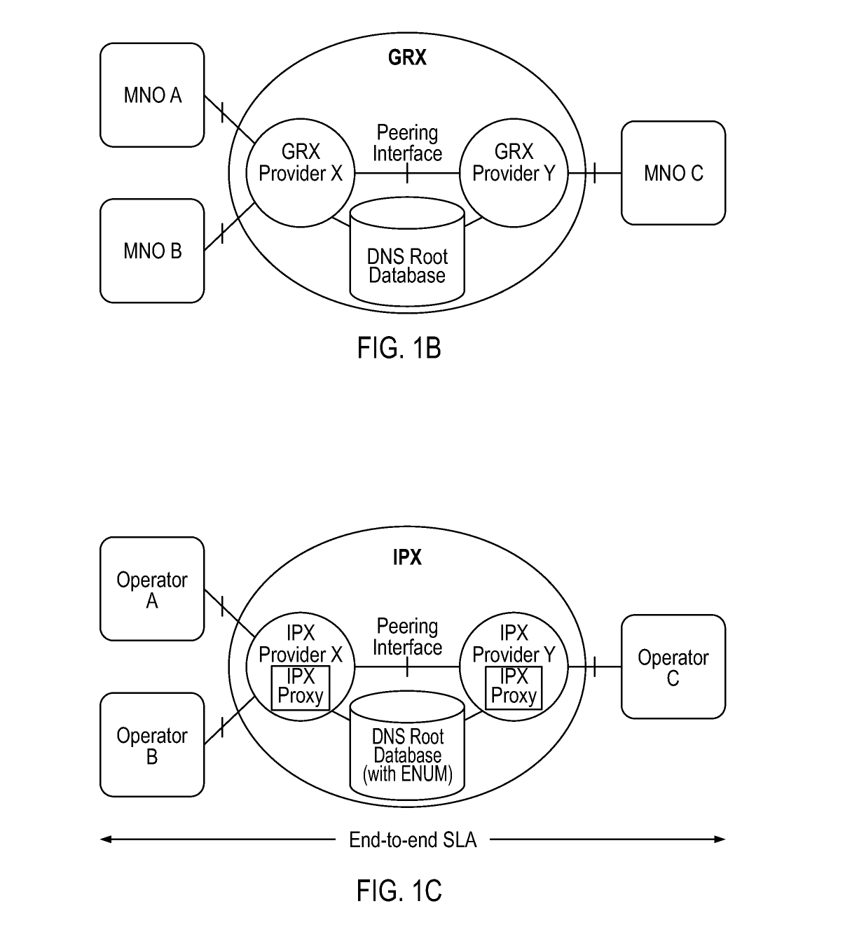

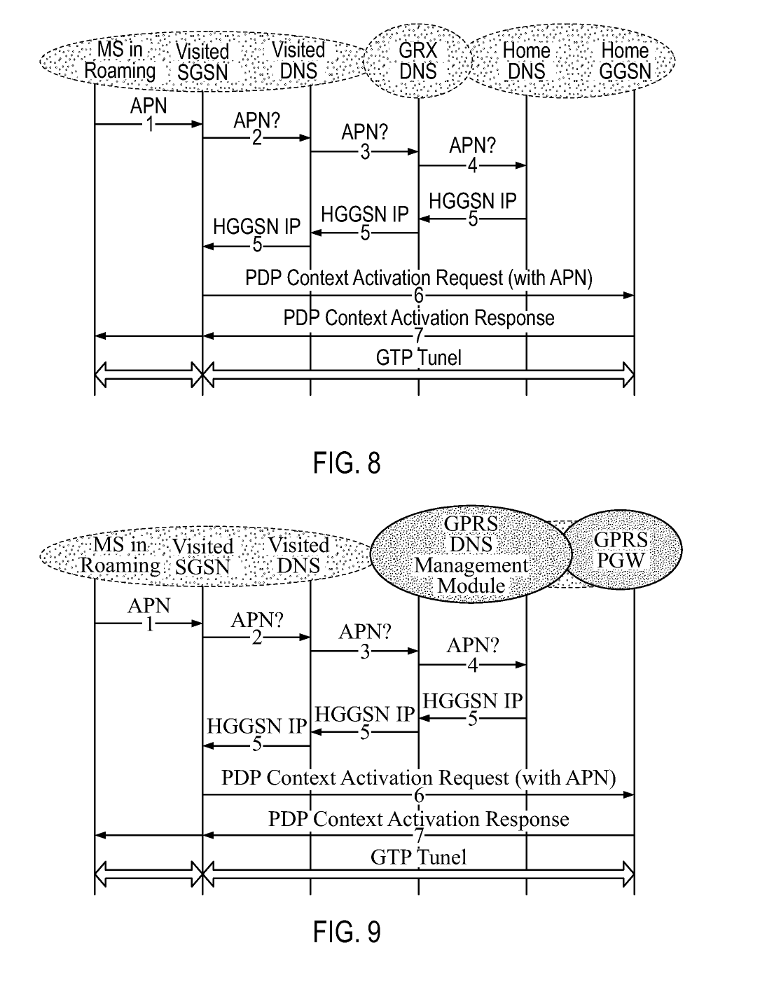

As shown in FIG. 8 and as explained in the background section and FIG. 1A, a roaming data user is handled in the following conventional way:
1. The roaming user is registered in the visited PLMN;
2. The visited SGSN 730 function requests a home subscription by sending a mobile application part (MAP) insert subscriber data message to the home PLMN home location register (HLR) 740;
3. The home PLNM HLR 740 requests a default APN for the subscriber;
4. The domain name system function resolves the provided APN to an IP address at the home GGSN 750 via established a GRX/IPX interconnect agreement and respective IPX/GRX routes;
5. GRX DNS turns to a home DNS server to handle the APN;
6. The visited DNS tries to resolve this APN by sending a host resolution request to the home DNS;
7. The home DNS returns the address of the home GGSN 750;
8. The visited GSGN 760 establishes a GTP connection to the home GGSN 750; and
9. The home GGSN 750 terminates a user IPCAN session and allows access to internet data services for the roaming user.

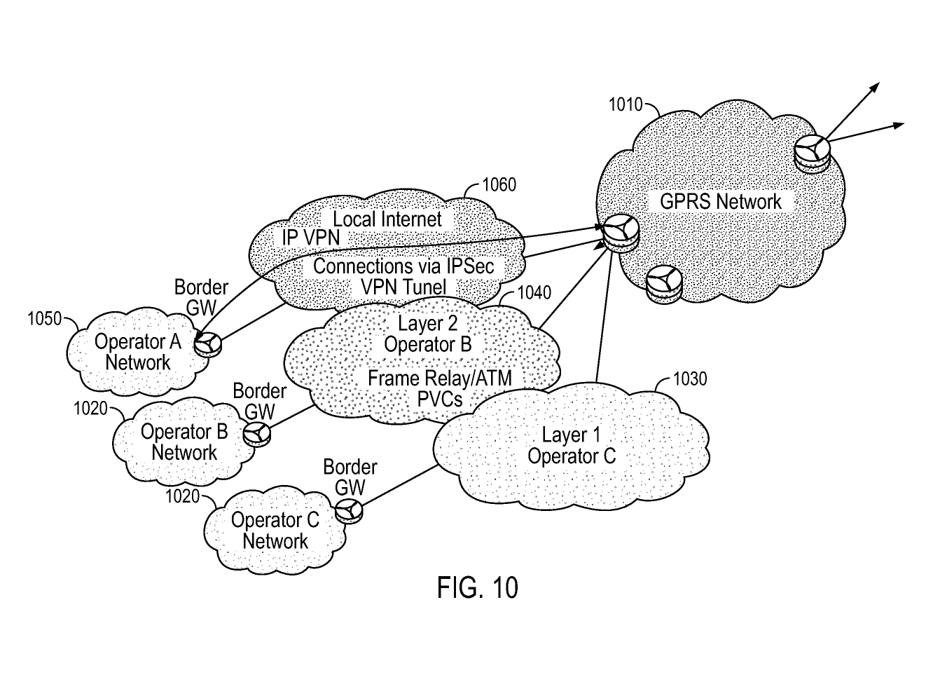

As shown in FIG. 9, the proposed cloud-based system replaces the traditional message flow by introducing virtual packet gateway functionality with a message flow as follows:
1. Roaming user registered in visited PLMN;
2. Visited SGSN function requests home subscription by sending a MAP insert subscriber data message to the home PLMN home location register (HLR);
3. Home PLNM HLR request with default APN name for subscriber;
4. Visited DNS function resolves provided APN to IP address to cloud DNS function via established cloud interconnect agreement and respective cloud routes;
5. Cloud DNS function returning cloud DNS server to handle the APN;
6. Visited DNS tries to resolve this APN by sending host resolution request to cloud DNS Function;
7. Cloud DNS function returns the address of virtual PGW;
8. Visited GSGN establish GTP connection to virtual PGW; and
9. Virtual PGW terminates user IPCAN session and allows access to internet data services for the roaming user.

### Management Module

The Management Module 710 keeps a visiting subscriber repository, referred to as a roaming user database (RUD). The RUD is a database of subscribers that are handled by the cloud-based system. Subscribers are added to this database by a special provisioning process made by the home operator.

The RUD maintains information on subscriber attributes such as Mobile Subscriber Identity, Mobile Subscriber ISDN Number—MSISDN, relationship to attached data plan and tariff.

The Management Module 710 is also responsible for dynamically resolving Internet domain names for home GPRS subsystems hosts (DNS function). This function substitutes for operator Access Point Names to local PGW hosts. The Management Module 710 stores roaming subscriber subscriptions, tariff plans and data usage. It also handles defined prepaid logic for the roaming subscriber (charging function) and stores data usage Call detailed Records (charging function).

Other Management Module functions 710 include allocating Internet addresses for user terminal via a radius protocol, providing an operator portal to handle roaming subscriptions (portal function), providing IP Sessions with additional policy control function (policy function) and providing operational support for system facilities.

The cloud-based business portal provides operational customer relationship management (CRM) and a business framework for the MNOs. CRM is the service portal in the cloud-based where each operator has portal access and a certain number of functions: business framework, service creation tools for home operators, traffic counters as visited ones, statistics and reports, service level agreements (SLA) and associated tools, fraud reporter and self-selling package master, end user redirect portal, M2M, etc.

The CRM portal is the business logic engine connected to all vital network elements of the cloud-based infrastructure, enabling the realization of a data roaming eco-system. The portal and the business logic is also part of multi-country management modules of the cloud-based system.

The business framework is the online tool for MNOs where the MNO may agree to the general terms and conditions and subscribe for cloud-based services for immediate or conditional launch. The MNO can define and obtain their roaming package settings and their names, to be offered to the end users for the particular operator. For example, MNO may create a simple package of a certain size (50 Mb, 500 Mb, 2 Gb or any other relevant package size for the MNO), advanced packs with VoIP capabilities and QoS, partner packages—“serve only FaceBook wherever you go” or enterprise packages with unlimited use of MB and private VPN.

Defined packages can be offered to the end users with prices defined by the MNO. The MNO will buy the packages according to the business model defined in the agreement.

Another available service is the ability to retrieve statistical data of usage of the packages by the subscribers abroad and a recommendation engine for the best valued packages.

Traffic counters will be available for operators acting in visited MNO roles—online reconciliation and detailed statistics from cloud-based management modules with online financial data and reconciliation reports. SLA and associated tools will be available on the cloud-based system to product network reports by roaming routs, call center statistics from the cloud-based second layer support, ticketing and remedy tools.

Other SLA tools of the cloud-based system include advanced capabilities to prevent fraud attempts. Operators may compile private fraud reports or black lists and define their use in the cloud-based system.

A self-selling package master enables the option to define default packages and select and assign a package to the end-user automatically. If the end user never purchases any roaming packages, yet appears on a visited network as a data roamer, the cloud-based system will recognize the end-user and automatically assign a default package with advice for online purchasing of the relevant package from the home operator. The end user will be automatically redirected to a portal that will automatically offer a new package to purchase if the end user consumed the previously purchased package.

M2M is a separate portal framework for worldwide M2M mobility and integrated M2M services with M2M control center capabilities. Sophisticated, yet intuitive cloud-based data roaming service will bring profitability and agility to the operator and improved service and cost base to the subscriber community while also meeting regulatory objectives. Associated analytic tools provide operator customers with insight into their subscribers' utilization enabling better definition and targeting of their data roaming products and services to maximize their subscriber loyalty, value and experience.

The embodiments described above may be implemented by software, hardware, or firmware (or combinations thereof) system, process or functionality, or component thereof, that performs or facilitates the processes, features, and/or functions described herein (with or without human interaction or augmentation). Software components may be stored on a computer readable medium and may be integral to one or more servers, or be loaded and executed by one or more servers. One or more components may be grouped into an engine or an application and implemented by at least one processor of a computing device.

### Cloud GRPS Revenue Model

In terms of a revenue model, two types of inbound tariff regulation can be used. The first type would be based on floating tariffs for each operator that take into an account the unique situation of this operator in terms of inbound and outbound roamers and would propose the inbound tariff for this specific operator that would maximize the usage/income combination from inbound customers. These inbound tariffs of the operators will also serve as the price formulation basis for home operators when selling the data packages to outbound roamers.

A second type of the tariff could be based on rigid pricing which in turn is divided into two subtypes. An inbound rigid price for all operators, periodically calculated and dictated by the cloud-based system. Such tariff formulation will also include some compensation paybacks for greatly outbalanced operators. Alternatively, a rigid inbound price could be set for every operator based on its data price for native users.

The proposed models do not set the outbound prices when these are offered to the roamer by his home network and the latter is free to set it equal, lower or higher than the inbound price. However, market forces will likely bring this end user price close to the inbound tariff prices or even lower.

As the inbound price which serves the basis for end user prices is somewhat close or similar to local prices of the visited network for all home operators in the country, natural competition forces will drive end user prices down from existing levels to those, close to that of inbound prices, while currently these end user prices are based on extremely high IOT rates.

The cloud-based income model is not based on any margin on top of either rigid or floating inbound tariffs. Thus, the cloud-based system does not directly affect prices and no regulation issues are anticipated. In addition there will be an option to separately determine and price additional traffic types (Google, Facebook, Skype, Twitter . . . ) to enable the operator to recover a greater share of the margins that are being lost to the content providers.

One or more embodiments of the invention have been described. Nevertheless, it will be understood that various modifications may be made. For example, suitable results may be achieved if the steps of described techniques are performed in a different order and/or if components in a described system, architecture, device, or circuit are combined in a different manner and/or replaced or supplemented by other components. Accordingly, other implementations are within the scope of the following claims.

The features described in the following claims should be interpreted consistent with standards deemed necessary to meet patentable subject matter requirements as those standards are revised from time to time. For example, if necessary to meet patentable subject matter requirements, certain functional aspects of the following claims can be interpreted as means plus function or step plus function claims under 35 USC §112, (f) (sixth paragraph).

1. A method of handling charges of a subscriber of a home network roaming on a visited network, comprising:
intercepting one or more call detail record produced by the visited network prior to transmission of a data file that includes the one or more call detail record to a data clearinghouse; and
removing an identified call detail record from the data file when the subscriber for the identified call detail record has a special international roaming arrangement.

2. The method of claim 1, further comprising:
sending the removed call detail record to a first server connected between the visited network and the home network.

3. The method of claim 1, further comprising:
transmitting the data file to a data clearinghouse connected between the visited network and the home network.

4. The method of claim 1, further comprising:
comparing the one or more call detail record to records in a database that include subscribers with a special international roaming arrangement.

5. The method of claim 1, wherein intercepting comprises intercepting the one or more call detail record by a first server installed at the visited network.

6. A method of handling roaming charges for a subscriber of mobile services on a visited network, comprising:
comparing one or more call detail record to records in a database that include subscribers with a special international roaming arrangement;
creating a special roaming customer record from the call detail record when the subscriber is identified as having a special international roaming arrangement;
forwarding the special roaming customer record of the identified subscriber to a remote server connected to the visited network and a home network of the identified subscriber; and
forwarding a data file that includes the call detail record of the subscriber to a data clearinghouse when the subscriber is not identified as having a special international roaming arrangement.

7. The method of claim 6, further comprising:
receiving the one or more call detail record from a mediation billing platform of the visited network.

8. The method of claim 6, further comprising:
providing real-time updates of the records in the database to identify each subscriber with a special international roaming arrangement.

9. The method of claim 6, further comprising:
intercepting the one or more call detail record for the subscriber prior to receipt by a billing system of the visited network.

10. The method of claim 6, further comprising:
intercepting the one or more call detail record for the subscriber prior to receipt by a roaming relations manager of the visited network.

11. The method of claim 6, further comprising:
intercepting the one or more call detail record for the subscriber prior to transmission of the call detail record to a data clearing house.

12. The method of claim 6, wherein the data file comprises a transferred account procedure (TAP) file.

13. The method of claim 6, wherein the data file comprises a cellular intercarrier billing exchange record (CIBER).

14. A method of handling charges for mobile data roaming of a subscriber of mobile services on a foreign network, comprising:
intercepting a call detail record at the foreign network for the subscriber that accesses the foreign network;
comparing the call detail record of the subscriber to records in a database that include subscribers with a special international roaming arrangement;
routing the call detail record to a global roaming partnership system connected to a plurality of networks when the subscriber is identified as having the special international roaming agreement; and
routing the call detail record to a data clearinghouse when the subscriber is not identified as having the special international roaming agreement.

15. The method of claim 14, further comprising:
removing the call detail record from records sent from the foreign network to the data clearinghouse when the roaming subscriber is identified as having the special international roaming arrangement.

16. The method of claim 14, further comprising a first server at the visited network that includes the database, wherein comparing comprises comparing the call detail record of the subscriber to records in the database on the first server at the visited network.

17. The method of claim 14, further comprising a second server connected to the visited network and a home network of the subscriber, wherein comparing comprises comparing the call detail record of the subscriber to records in the database on the second server connected to the visited network and the home network.

18. A system to handle charges for international roaming of a subscriber of mobile services on a foreign network, comprising:
a first mini data clearinghouse installed on the foreign network to compare one or more call detail record produced by the foreign network to records in a database to identify subscribers with special international roaming agreements; and
a global roaming partnership system connected to the first mini data clearinghouse and to a second mini data clearinghouse installed at the home network of the subscriber, wherein the global roaming partnership system includes a master database for subscribers with special international roaming agreements, wherein the master database updates the database at the first mini data clearing house;
wherein the first mini data clearinghouse server determines whether to forward the one or more call detail record to the data clearinghouse for the foreign network when the subscriber does not have a special international roaming arrangement or to forward the one or more call detail record to the global roaming partnership system when the subscriber has a special international roaming arrangement.

19. The system of claim 18, further comprising:
a database management system residing at the global roaming partnership system to manage the master database.
